(19) United States
(12) Patent Application Publication
(10) Pub. No.: US 2002/0099810 A1
(43) Pub. Date: Jul. 25, 2002

(54) Method, system & apparatus for interactive multimedia remote processor control, diagnostics and maintenance

(76) Inventors: Martin Kiesel, Poxdorf (DE); Andreas Polz, Erlangen (DE); Peter Wagner, Hersbruck (DE)

Correspondence Address: Siemens Corporation, Intellectual Property Department, 186 Wood Avenue South, Iselin, NJ, 08830, US

(21) Appl. No.: 09/938,447

(22) Filed: Aug. 24, 2001

(30) Foreign Application Priority Data
Jan. 25, 2001 (DE) 101 03 333.8
Jun. 20, 2001 (DE) 101 29 566.9

(51) Int. Cl. G06F 15/173; G06F 9/00

(52) U.S. Cl. 709/223

(57) ABSTRACT

A method, system & apparatus for interactive multimedia remote processor control, diagnostics and maintenance. The multimedia connection improves data exchange between an automated machine (MA) or its user (US) and a service unit (SE). One or more UMTS-connections (UC 1, UC 2) are foreseen. Via these UMTS-channels, multimedia information can be transferred in real time. In this manner, the user (US) receives visualized instructions from a serviceman (SE) and the serviceman (SE) receives online images and data for monitoring, diagnosis or maintenance.

### BACKGROUND OF THE INVENTION

1. Field Of The Invention

The present invention relates to a method, system & apparatus for interactive remote processor control, diagnostics and maintenance using multimedia and, more particularly, to a multimedia control device and interactive process for control, regulation, monitoring and/or diagnosis of a remote device.

2. Related Information

Automated machines, such as those found in the industrial automation industry, require supervision and maintenance. Such machines, whether processor-controlled “smart” machines or non-processor-controlled “dumb” machines, at times malfunction or fail. Such a failure is critical in industries where a break-down of such a machine may disrupt production operations or even bring a plant off-line.

At the present time, automated machines are typically run by a user or maintained and monitored by service personnel on-site. Likewise, it is common practice that the on-site user communicates with a service center (hotline) over the telephone in order to operate the automated machine according to specifications. The communication between the user and a serviceman can generally be carried out not only by means of a so-called telephone hotline, but also via telefax or e-mail.

There are known techniques by which control data are transferable to a remote computer so that control parameters can be observed and modified by a so-called tele-service. A disadvantage of the known systems is that the user continues to play an integral role in the diagnosis and maintenance of the automated machine. This is problematic because, the user is not, as a rule, sufficiently trained in automation technology that he/she can readily implement the instructions of the service personnel. Thus, it matters not that the service personnel at the remote location is better informed, when the user at the automated device location is unable to utilize or follow the serviceman's instruction to correct the problem or diagnosis a situation.

Conversely, it is also difficult or impossible for the service personnel to formulate a diagnosis for the automated machine if data or parameters can only be transmitted to the service personnel by way of the untrained user. Worse, the situation is aggravated when the user reports inaccurate or incorrect information to the remote serviceman. The situation is almost worsened by such ineffective tele-service.

### OBJECTS & SUMMARY OF THE INVENTION

The object of the present invention is to eliminate the importance and reliance upon the user at the automated machine location.

A further object of the present invention is improve data exchange between an automated machine or its user and a remote service unit.

Another object of the present invention is to provide an interactive system and process by which the serviceman at the remote location controls, diagnoses and performs operations to correct the automated device.

According to the present invention, these objects are achieved by a control device for control, regulation, monitoring and/or diagnosis of an instrument with a processing apparatus for the processing and communication of data from/with a remote data-processing device, whereby the processing apparatus is capable of processing and transferring multimedia information.

Further, the above-mentioned object is achieved by a method for control, regulation, monitoring and/or diagnosis of an instrument by providing a control device and a remote data-processing device that are connected with each other via a telecommunications apparatus. In this aspect, control and/or monitoring data is transferred in the form of multimedia information between the control device and the data-processing device in real time via the telecommunications apparatus.

In this way, the present invention permits multimedia transfer capability of data and information to a user of an automated machine or to a serviceman by the opposite party. The serviceman, for example, can therefore observe the automated machine online with a television monitor and is not dependent on the descriptions of a user. Advantageous further developments of the control device according to the present invention and the method according to the present invention are specified in the following description of the invention.

### BRIEF DESCRIPTION OF THE DRAWINGS

FIG. 1 is schematic diagram of a simple communication between the user of a machine and a remote serviceman according to the current state of technology;

FIG. 2 is a schematic diagram of a tele-service apparatus according to the current state of technology;

FIG. 3 is a schematic diagram of a UMTS-service connection;

FIG. 4 is a schematic diagram of a service connection with an augmented-reality device;

FIG. 5 is a schemtic diagram of a service system with multiple service personnel; and

FIG. 6 is a schematic diagram of a service system with a UMTS-network with multiple service apparatuses.

### DETAILED DESCRIPTION OF THE PREFERRED EMBODIMENTS

The following embodiments represent preferred applications of the present invention as set forth in the appended figures with like reference numerals referring to like elements in the specification.

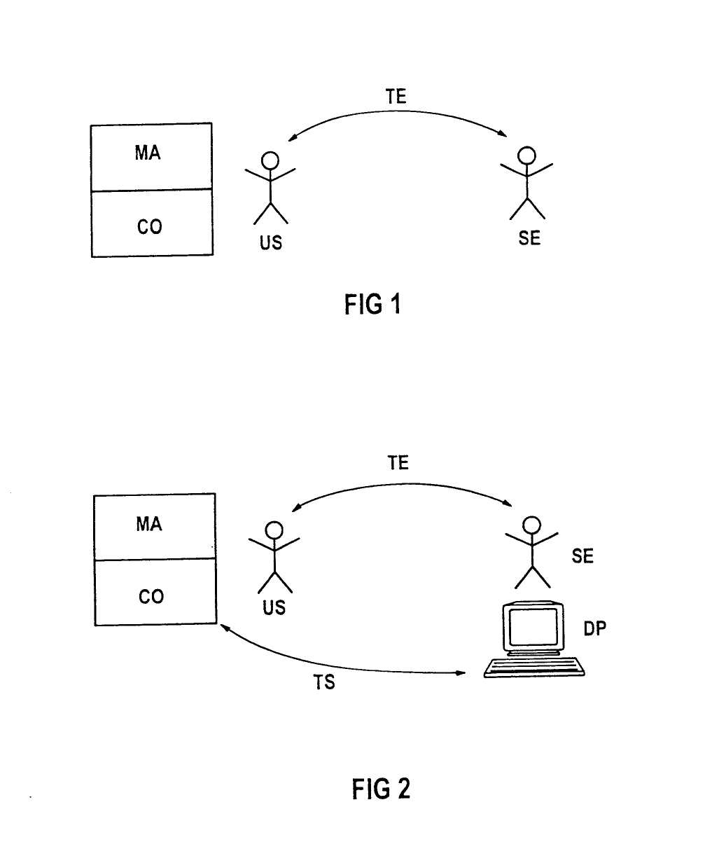

The design of the device according to the present invention or the system according to the present invention will first be illustrated on the basis of the current state of technology, according to FIGS. 1 and 2.

Corresponding to FIG. 1, a machine (MA) is shown having a control unit (CO). A user (US) operates the machine (MA) or the control (CO). The user (US) is in contact with a so-called remote serviceman (SE) via telephone or fax (TE). To do so, the serviceman may be operating a hotline, for example.

According to FIG. 2, the telephone connection (TE) between user (US) and serviceman (SE) has been supplemented by a tele-service connection (TS). Within the framework of such a tele-service, the remote serviceman (SE) can see the control parameters on a workplace monitor and modify them. In addition, the serviceman (SE) can send the modified control parameters back to the control (CO) or to the machine (MA) via the tele-service connection (TS) as necessary.

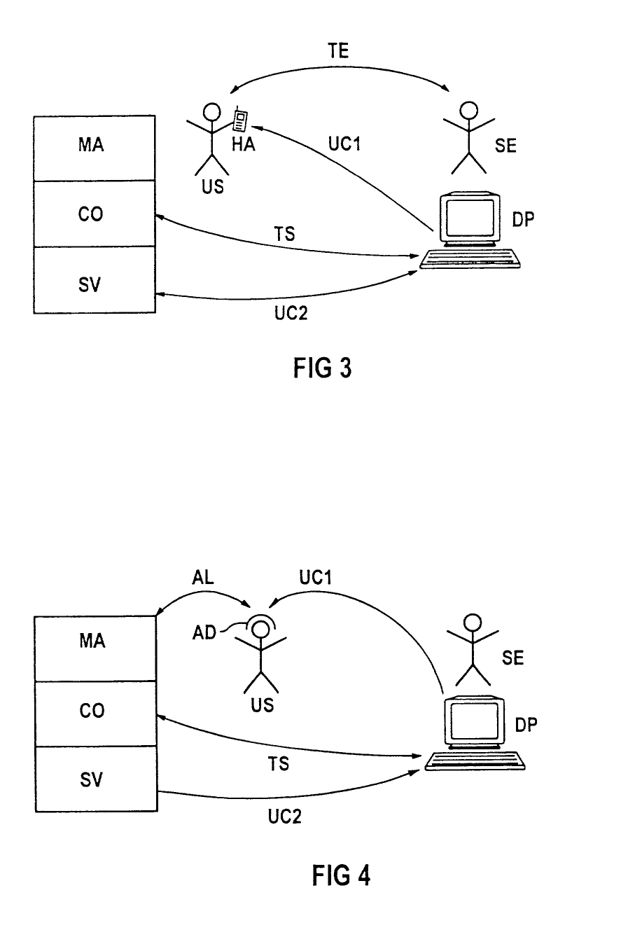

Now referring to the present invention as illustrated in FIG. 3, the basic elements described with reference to FIGS. 1 and 2 are applicable. In the present invention of FIG. 3, it is intended that the invention be applicable to automated machines of a general nature. In addition, it is contemplated that the present invention be applicable to industrial machinery. Further, the control may be a processor such as a computer processor typically associated with automated machinery, such as a programmable logic controller. Of course, the present invention may be employed with either “smart”, i.e., processor-controlled machines, or “dumb”, non-processor-controlled machines.

According to the present invention, the data communication described between user (US) and serviceman (SE) is formed by two UMTS-connections (UC 1 and UC 2) (Universal Mobile Telecommunications System). Via a UMTS-server (SV) on the control (CO), the serviceman (SE) receives multimedia, including, but not limited to audio, video, DVD, or MP3, or other known and future multimedia forms. It is an aim of the present invention to capture critical information regarding the status of the automated machinery as multimedia and transmit the same to the serviceman using the UMTS connection. Thus, the multimedia includes live images or moving images of the machine in real time over the UMTS-connection (UC 2) from a WebCam™, for example. The WebCam™ is positioned to observe critical information regarding the status of the automated machine.

With the present invention, the serviceman (SE) is provided with accurate and reliable information in the form of multimedia data regarding the automated machine. In response, the serviceman makes a correct assessment of the automated machine and provides, in response thereto, meaningful instructions for operating the machine (MA) to the user (US) over the UMTS-connection (UC 1) on a UMTS-device (HA).

In the present invention, such a UMTS-device (HA) may consist of any UMTS supported device including a UMTS equipped cellphone, handheld or, for example, a personal digital assistant (PDA). In addition, the invention includes, for example, computers, such as personal computers, lap tops, and the like.

Another aspect of the invention includes composing instructions in the form of animations and moving animations by the serviceman and sent, via the UMTS connection, to the user at the machine location. In this manner, the user (US) is enabled using the multimedia instructions to carry out potentially complicated instructions from the serviceman (SE). This is far superior to the previous method of communicating the instructions to the user orally, which was subject to faulty interpretation by the user and resulted in mishandling the problem.

In another aspect of the invention, the UMTS-connection (UC 2) permits direct observation of the operating condition of the machine (MA) by the serviceman (SE), without being dependent upon the knowledge of the user (US). In other words, the invention does not involve the user to observe the status of the machine. This provides the serviceman with the ultimate degree of information integrity because the human “factor” is removed.

At this time, it is believed that a discussion of UMTS Universal Mobile Telecommunications System in order. UMTS is a Third Generation (3G) mobile technology that delivers broadband information at speeds up to 2 Mbit s/sec. Besides voice and data, UMTS delivers audio and video to wireless devices anywhere in the world through fixed, wireless and satellite systems. At the time of the invention, it is worthy to note that UMTS had not yet been launched.

In the definition of UMTS, broadband a type of data transmission in which a single medium (wire) can carry several channels at once. Cable TV, for example, uses broadband transmission. In contrast, baseband transmission allows only one signal at a time. Most communications between computers, including the majority of local-area networks, use baseband communications. An exception is B-ISDN networks, which employ broadband transmission. B-ISDN A standard for transmitting voice, video and data at the same time over fiber optic telephone lines. Broadband ISDN can support data rates of 1.5 million bits per second (bps), but it has not been widely implemented.

To be clear, medium refers to the cables linking workstations together. There are many different types of transmission media, the most popular being twisted-pair wire (normal electrical wire), coaxial cable (the type of cable used for cable television), and fiber optic cable (cables made out of glass). Of course, the present invention is not limited to physical media, but may utilize wireless media, such as satellite or cellular communication technology.

UMTS is a part of the International Telecommunications Union's ‘IMT-2000’ vision of a global family of ‘third-generation’ (3G) mobile communications systems UMTS will play a key role in creating the future mass market for high-quality wireless multimedia communications that will approach 2 billion users worldwide by the year 2010. It is expected, therefore, that the present invention will be wildly popular.

Furthermore, UMTS enable tomorrow's wireless Information Society, delivering high-value broadband information, commerce and entertainment services to mobile users via fixed, wireless and satellite networks. UMTS speeds convergence between telecommunications, IT, media and content industries to deliver new services and create fresh revenue-generating opportunities. UMTS delivers low-cost, high-capacity mobile communications offering data rates up to 2 Mbit/sec with global roaming and other advanced capabilities.

UMTS licenses have already been awarded in several European countries. UMTS experimental systems are now in field trial with leading vendors worldwide. UMTS builds on today's significant investments in second generation mobile systems UMTS has the support of several hundred network operators, manufacturers and equipment vendors worldwide. UMTS is one of the major new third generation mobile communications systems being developed within the framework which has been defined by the ITU and known as IMT-2000.

The subject of intense worldwide efforts on research and development throughout the present decade, UMTS has the support of many major telecommunications operators and manufacturers because it represents a unique opportunity to create a mass market for highly personalised and user-friendly mobile access to tomorrow's “Information Society”.

UMTS delivers pictures, graphics, video communications and other wide-band information as well as voice and data, direct to people who can be on the move. UMTS builds on and extend the capability of today's mobile technologies (like digital cellular and cordless) by providing increased capacity, data capability and a far greater range of services using an innovative radio access scheme and an enhanced, evolving core network.

The launch of UMTS services from the year 2001 will see the evolution of a new, “open” communications universe, with players from many sectors (including providers of information and entertainment services) coming together harmoniously to deliver new communications services, characterised by mobility and advanced multimedia capabilities. The successful deployment of UMTS will require new technologies, new partnerships and the addressing of many commercial and regulatory issues.

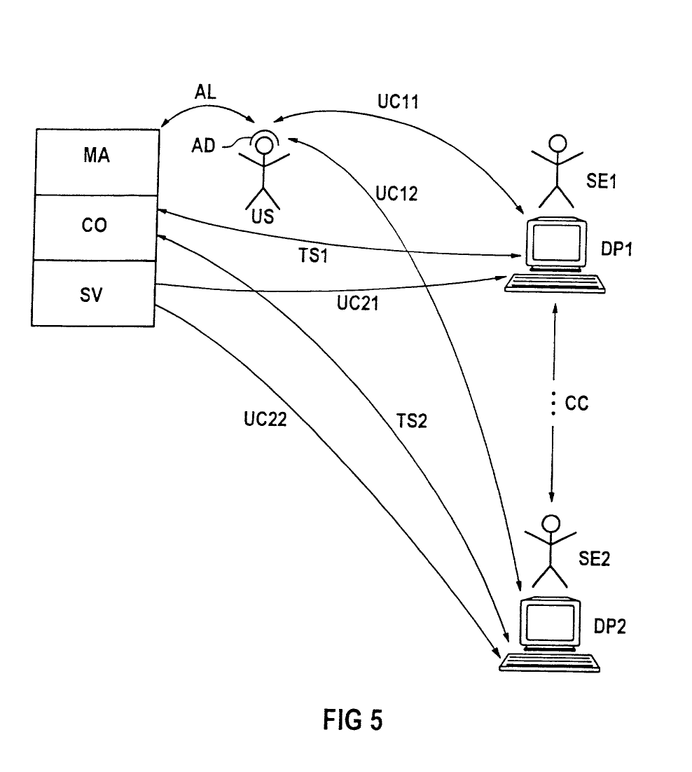

In the present invention according to FIG. 4—which represents a further development of the invention according to FIG. 3—an augmented-reality device (AD) for the user (US) is employed. The augmented-reality device (AD) is connected with the data-processing system (DP) of the serviceman (SE) via the UMTS-connection (UC 1). In addition, the augmented-reality device (AD) is connected with the machine (MA) or its control (CO) via an augmented-reality loop (AL).

With this implementation, the serviceman (SE) directly intervenes in the augmented-reality device (AD) of the user (US) by way of the UMTS-connection (UC 1). The user (US) communicates with the machine (MA) via the augmented-reality loop, whereby current or recorded machine data are visualized and animated, for example. The serviceman (SE) can link directly into this augmented-reality loop (AL). By way of example, augmented-reality devices (AD) include goggles into which video sequences can be fed. The telephone or fax connections (TE) between user (US) and serviceman (SE) shown in FIGS. 1 through 3 may continue to exist, of course.

Augemented reality systems, such as a Virtual Reality (VR) systems enable one or more users to move and react in a computer-simulated environment. Various types of devices allow users to sense and manipulate virtual objects much as they would real objects. This natural style of interaction gives participants the feeling of being immersed in the simulated world. Virtual worlds are created by mathematical models and computer programs.

Virtual reality simulations differ from other computer simulations in that they require special interface devices that transmit the sights, sounds, and sensations of the simulated world to the user. These devices also record and send the speech and movements of the participants to the simulation program. To see in the virtual world, the user wears a head-mounted display (HMD) with screens directed at each eye. The HMD also contains a position tracker to monitor the location of the user's head and the direction in which the user is looking. Using this information, a computer recalculates images of the virtual world-13 a slightly different view for each eye—to match the direction in which the user is looking, and displays these images on the HMD. The computer must generate these new views at least ten times a second in order to prevent the user's view from appearing halting and jerky and from lagging behind the user's movements

Users hear sounds in the virtual world through earphones in the HMD. The information reported by the position tracker on the HMD can also be used to update audio signals. When a sound source in virtual space is not directly in front of or behind the user, the computer transmits sounds to arrive at one ear a little earlier or later than at the other and to be a little louder or softer and slightly different in pitch. However, as with visual imagery, there are currently scientific and engineering challenges that must be overcome in order to simulate accurately all the sounds heard in the physical world. However, the state of the art of VR is not a limitation of the present invention and it is expected that, as VR technology improves, so too will the effectiveness of VR as employed with the present invention.

The haptic interface, for example, relays the sense of touch and other physical sensations in the virtual world. Currently, with the use of a glove and position tracker, the computer locates the user's hand and measures finger movements. The user can reach into the virtual world and handle objects but cannot actually feel them. The haptic device can simulate certain sensations that are felt when a person taps a hard surface, picks up an object, or runs a finger across a textured surface. To simulate these sensations, a set of computer-controlled motors faster and more accurate than any presently available would have to generate force feedback by physically pushing against the user. The haptic also determines how a user would wear these motors and the wiring needed to control them. Touch sensations are synchronized with the sights and sounds users experienced in their HMDs. A current solution that can apply small forces, through a mechanical linkage, to a stylus held in the user's hand. Users feel when the point of the stylus encounters a virtual object, and they drag the stylus across the surface to feel its texture and surface geometry.

The present invention shown in FIG. 5 anticipates multiple service centers or servicemen (SE 1, SE 2) who are in contact with the machine (MA) to be controlled or with the user (US) via their data-processing systems (DP 1, DP 2). In addition to the connections depicted in the previous FIGS. 1 through 4, one or more further broadband or UMTS-communication connections (UC 11, UC 12, UC 21, UC 22) exist for multimedia data exchange between the user (US) or the machine (MA) and the servicemen (SE 1, SE 2). The UMTS-connections (UC 11 and UC 12) thereby have the same function as the UMTS-connection (UC 1) in FIG. 4, and the UMTS-connections (UC 21 and UC 22) likewise have the same function as the UMTS-connection (UC 2) in FIG. 4.

In similar fashion, a tele-service connection (TS 1, TS 2) can be established between each service unit (SE 1, SE 2) and the control (CO) of the machine (MA). With this system, for example, in addition to the serviceman for the control manufacturer (SE 1), one or more further servicemen (SE 2), e.g., from the manufacturer of the machine, can also communicate, in particular simultaneously, with the user (US) of the machine (MA). Conference circuits can be set up via the corresponding feedback channels of the UMTS-connections (UC 11, UC 12) and/or by way of a special conference connection (CC).

As is in the previous embodiments, the UMTS-connections in the invention shown in FIG. 5 can be replaced in whole or in part by other broadband transfer connections that can transfer multimedia information in real time.

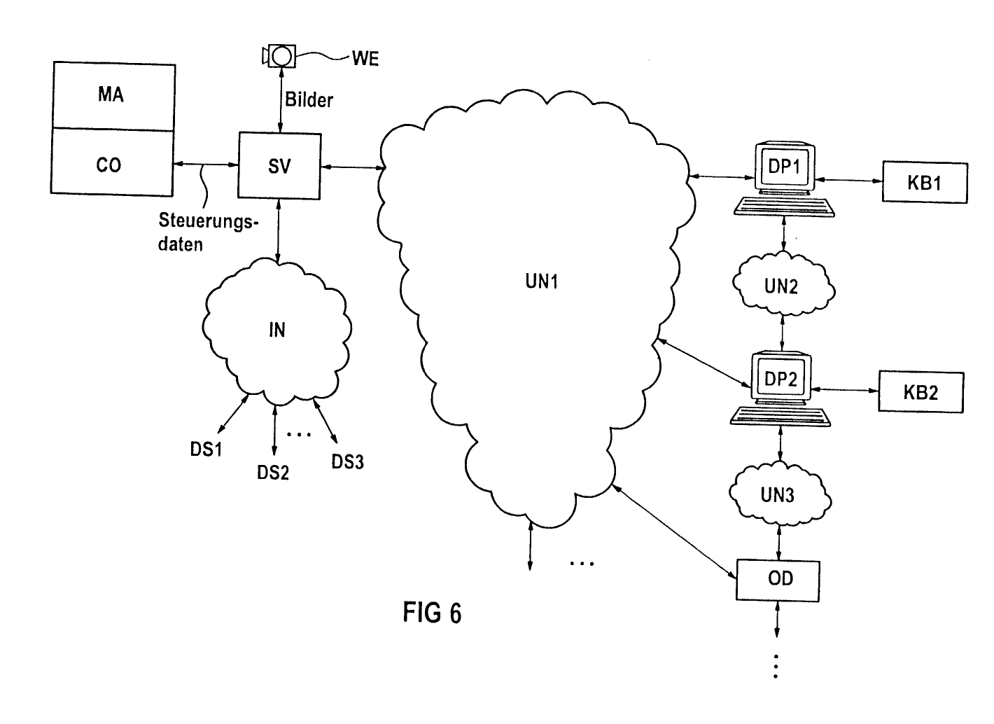

In the present invention depicted in FIG. 6, the actual conditions of the machine (MA) to be controlled are observed with a WebCam™ (WE). The WebCam™ (WE) delivers the images to the UMTS-server (SV), which in turn communicates control data to the control unit (CO) of the machine (MA). The UMTS-server (SV) is connected to the Internet or an intranet (IN). These can in turn be connected with multiple data servers (DS 1, DS 2, DS 3), e.g., for a so-called manufacturing execution system (MES), documentation, etc.

Furthermore, the UMTS-server (SV) has a connection to a UMTS-network (UN 1). This UMTS-network (UN 1) is connected with multiple data-processing systems (DP 1, DP 2) from various service providers and an operating data registry (OD), for example. The data-processing systems (DP 1, DP 2) of the service providers are each connected with their own so-called knowledge bases (KB 1, KB 2). In addition, they are connected with one another and with the operating data registry (OD) by UMTS-networks (UN 2, UN 3). The data networks (IN, UN 1, UN 2, UN 3) employed in this fourth embodiment can be replaced by other appropriate networks and combined with one another as desired.

In the scenario shown in FIG. 6, various service apparatuses, e.g., from a control manufacturer, a machine constructor, an operating data registry, etc., can therefore be connected with the UMTS-server (SV) of a machine control (CO) over a UMTS-network (UN 1). The individual service apparatuses can thereby also establish conference circuits with the UMTS-server (SV) or the non-depicted user (US) via UMTS-networks (UN 2, UN 3) or other communications media.

With the system according to the present invention, the various features and their several advantages were described. Thus, it was described above in more detail the various functionality of features available with the present invention. With the present invention, it is possible to provide trace functionality via UMTS-online trace with remote operation (online trace with remote data storage). In addition, transfer of moving and/or still machine images is possible. Further, there is the capability of transfer of real-time data from a control/machine with remote evaluation (quality data, production data, service data, . . . ). In addition, the present invention provides presentation of an actual production process via a camera. Further, there is provided visualization of dynamic and static machine and control parameters. With the invention, image information is transferred and the serviceman is able to monitor/diagnos, control and troubleshoot the remote automated device.

With these capabilities, remote diagnosis, remote servicing or remote user guidance can be realized according to the present invention for industrial machines. As described in more detail above, the remote serviceman has access to a plethora of data concerning the automated machine. This includes, but is not limited to, control data used to control the remote device. In addition, there is accesible by the serviceman has accesible moving images. For example, there is provided actual image of the machine, e.g., via WebCam™. Further, there is optional access to further data servers, e.g., documentation, MES, etc. (e.g., which material is currently being processed, which order, etc.)

With the present invention, the user is guided on-site by the remote serviceman. This is performed, for example, via transfer of instructions (e.g., special documents) to on-site visualization devices (e.g., OP, handheld, cellphone). In addition, the user may be guided through the display of the operation in the “augmented-reality goggles.” Likewise, as previously mentioned, a conference circuit can be established for, e.g., service calls or startup/optimization processes, for example, by the inclusion of various service departments, e.g., OEM and control manufacturer.

The present invention may be constructed using a compact design. In that instance the UMTS-server (SV) can be integrated into the machine (MA) or the control (CO), as shown in FIGS. 3, 4 and 5. In this manner, the invention further provides portability and compactibility.

1. An apparatus for a control device for providing multimedia monitoring and control of a remote machine, comprising:
a processor that processes and communication of data with said remote machine; and
multimedia information regarding a status of the remote machine; and
a multimedia connection coupled to said processor providing a multimedia transmission connection to the remote machine and transmitting said multimedia information regarding a status of the remote machine:

2. The apparatus according to claim 1, wherein the processor enables a UMTS connection.

3. The apparatus according to claim 1, further comprising a visualization device that generates visualization information regarding the status of the remote machine.

4. The apparatus according to claim 1, further comprising an augmented-reality device that generates the multimedia information from one ore more senses of a user in the vicinity of the remote machine.

5. The apparatus according to claim 1, wherein the telecommunication communication connection of is bi-directional.

6. The apparatus according to claim 1, further comprising a trace functionality transferred over the telecommunication link for realtime transmission of multimedia data connection.

7. The apparatus according to claim 1, further comprising a data-processing device coupled remotely with said machine for controlling the processing of the multimedia information.

8. The apparatus according to claim 7, wherein said data-processing device encompasses multiple data-processing units which have communication connections to one another and which each have a telecommunication connection for real-time transfer of multimedia information to the control device.

9. The apparatus according to claim 1, wherein the communication between the respective components is carried out over one or more UMTS-networks.

10. The apparatus according to claim 1, wherein the communication between the respective components is carried out over the internet.

11. A Method for a control device for providing multimedia monitoring and control of a remote machine, comprising the steps of:
processing information generated by the remote machine;
generating multimedia information regarding a status of the remote machine; and
providing a multimedia connection coupled to said processor providing a multimedia transmission connection to the remote machine and transmitting said multimedia information regarding a status of the remote machine.

12. The method according to claim 10, wherein the processor enables the UMTS connection.

13. The method according to claim 10, further comprising the step of generation visualization information regarding the status of the remote machine.

14. The method according to claim 10, further comprising the step of generating augmented-reality information from one ore more senses of a user in the vicinity of the remote machine.

15. The method according to claim 10, further comprising the step of sending the UMTS communication bi-directionally.

16. The method according to claim 10, further comprising the step of generating a trace functionality transferred over the UMTS connection.

17. The method according to claim 10, further comprising the step of remotely processing the multimedia information.

18. The method according to claim 16, further comprising the step of providing multiple data-processing units which have communication connections to one another and which each have a telecommunication connection for real-time transfer of multimedia information to the control device.

19. The method according to claim 10, further comprising the step of providing the communication between the respective components over one or more UMTS-networks.

20. The method according to claim 10, further comprising the step of providing communication between the respective components over the Internet (IN).
